(19) United States
(12) Patent Application Publication
(10) Pub. No.: US 2019/0213049 A1
(43) Pub. Date: Jul. 11, 2019

(54) DATA CONTROLLING METHOD OF DISTRIBUTED COMPUTING SYSTEM AND DISTRIBUTED COMPUTING SYSTEM

(71) Applicant: HITACHI, LTD., Tokyo (JP)

(72) Inventors: Naruki KURATA, Tokyo (JP); Katsuto SATO, Tokyo (JP); Nobukazu KONDO, Tokyo (JP)

(73) Assignee: HITACHI, LTD., Tokyo (JP)

(21) Appl. No.: 16/329,073

(22) PCT Filed: Feb. 15, 2017
(86) PCT No.: PCT/JP2017/005435

§ 371 Date: Feb. 27, 2019

(51) Int. Cl. G06F 9/50; G06F 9/38; G06F 11/20

(52) U.S. Cl. CPC G06F 9/5072; G06F 11/203; G06F 9/3861; G06F 9/3836

(57) ABSTRACT

First software operated on a first computer assigns data to be computed to second software operated on second computers. Second managers operated on the plurality of second computers respectively obtain data assignment information notified from the first software, and respectively notify the data assignment information to a first manager operated on the first computer. The first manager decides priority for the data to be computed transferred between the plurality of second computers based on the data assignment information. The first manager sets the priority to the network device.

### TECHNICAL FIELD

The present invention relates to the controlling mechanism of a massively distributed computing system in which a plurality of computers are connected by a network and a method thereof.

### BACKGROUND ART

A massively distributed computing system is a system that partitions a job requested by a user into computing units called tasks and executes the tasks in parallel by using a large number of computers, thereby computing the tasks at high speed.

In principle, the partitioning into the tasks is performed at the start of the execution of the job by assuming that the execution time is equal, but actually, the variation (skew) in the execution completion time caused between the tasks occurs, and a state where the task that has been already computed waits for the task in which the execution time is long occurs. Consequently, the efficiency of the distributed computing is lowered and the entire execution time becomes longer.

For example, at the occurrence of situations of unequal data placement in a computer to which the task is assigned, the lowering of the access speed to the storage device, and the like, the execution time of the task becomes longer than the execution time of the tasks assigned to other computers, so that the computers that have executed the tasks in which the execution time is short are brought into the standby state. Even in the same job, the skew occurrence degree is greatly different due to the different input data, so that it is difficult to adjust task placement by statically predicting the task execution time at the start of the execution.

To solve this problem, a method is known for dynamically performing task repartitioning by detecting the actual execution time and input data size of each task during execution (for example, Nonpatent Literature 1).

In addition, Patent Literature 1 discloses a method for controlling QoS (Quality of Service) for each type of data flowing on the network and for each user who owns the data in the distributed computing system.

### CITATION LIST

### Patent Literature

Patent Literature 1: U.S. Patent No. 2016/0094480

### Nonpatent Literature

Nonpatent Literature 1: Zoltan Zvara, “Handling Data Skew Adaptively in Spark Using Dynamic Repartitioning,”, Spark Summit 2016, June 2016

### SUMMARY OF INVENTION

### Technical Problem

However, in Nonpatent Literature 1, the distributed computing system is required to be modified for the task repartitioning, and consequently, there is a problem that the distributed computing system is inapplicable to commercial software that does not disclose the source code or does not permit the modification.

In addition, in Patent Literature 1, the optimization at the coarse granularity of the service unit and the user unit is enabled based on the predetermined policy, but there is a problem that it is not possible to cope with the lowering of the efficiency of the distributed computing due to the unequal execution time occurring in one job.

An object of the present invention is to reduce the variation in the completion time of tasks occurring in distributed computing without modifying the software of the distributed computing.

### Solution to Problem

The present invention provides a data controlling method of a distributed computing system that connects a first computer having a processor, a memory, and a network interface and a plurality of second computers each having the processor, the memory, and the network interface by a network device and controls data computed by the second computers. The method includes a first step in which first software operated on the first computer assigns data to be computed to second software operated on the second computers, a second step in which second managers operated on the plurality of second computers respectively obtain data assignment information notified from the first software, and respectively notify the data assignment information to a first manager operated on the first computer, a third step in which the first manager decides priority for the data to be computed transferred between the plurality of second computers based on the data assignment information, and a fourth step in which the first manager sets the priority to the network device.

### Advantageous Effects of Invention

According to the present invention, the variation in the completion time of the tasks occurring in the distributed computing is reduced without modifying the software of the distributed computing, and the execution time of the job introduced into the distributed computing system can be shortened.

### BRIEF DESCRIPTION OF DRAWINGS

FIG. 1 is a block diagram illustrating a first embodiment of the present invention and illustrating an example of a distributed computing system;

FIG. 2 is a diagram illustrating the first embodiment of the present invention and illustrating an example of shuffle computing in the distributed computing system;

FIG. 3 is a diagram illustrating a conventional example and illustrating an example in which skew occurs during the execution time due to the difference in the data size of each task in the distributed computing system;

FIG. 4 is a diagram illustrating the first embodiment of the present invention and illustrating an example in which the variation in the execution time of each task in the distributed computing system is relieved by the communication priority control of the shuffle;

FIG. 5 is a sequence diagram illustrating the first embodiment of the present invention and illustrating an example of the data priority control performed in the distributed computing system;

FIG. 6 is a diagram illustrating the first embodiment of the present invention and illustrating an example of participation information notified to a manager of the distributed computing system when a worker of the distributed computing system participates in the distributed computing system;

FIG. 7 is a diagram illustrating the first embodiment of the present invention and illustrating an example of separation information notified to the manager of the distributed computing system when the worker of the distributed computing system separates from the distributed computing system;

FIG. 8 is a diagram illustrating the first embodiment of the present invention and illustrating an example of a completion notification in order for the worker of the distributed computing system to notify the task execution completion to the manager of the distributed computing system;

FIG. 9 is a diagram illustrating the first embodiment of the present invention and illustrating an example of assignment notification information in order for the manager of the distributed computing system to notify the task execution start to the worker of the distributed computing system;

FIG. 10 is a diagram illustrating the first embodiment of the present invention and illustrating an example of shuffle information in order for the worker of the distributed computing system to provide the information about the shuffle of the task execution-started to a global priority manager;

FIG. 11 is a diagram illustrating the first embodiment of the present invention and illustrating an example of data in order for the global priority manager to provide hint information of the shuffle to a local priority manager;

FIG. 12 is a diagram illustrating the first embodiment of the present invention and illustrating an example of priority control information that the local priority manager sets to an NIC;

FIG. 13 is a diagram illustrating the first embodiment of the present invention and illustrating an example of priority control information that the global priority manager sets to a network switch;

FIG. 14 is a diagram illustrating the first embodiment of the present invention and illustrating an example of worker configuration information held by the global priority manager;

FIG. 15 is a diagram illustrating the first embodiment of the present invention and illustrating an example of task execution completion information of the task relayed by the global priority manager;

FIG. 16 is a diagram illustrating the first embodiment of the present invention and illustrating an example of task management information managed by the global priority manager;

FIG. 17 is a diagram illustrating the first embodiment of the present invention and illustrating an example of priority control information managed by the local priority manager;

FIG. 18 is a diagram illustrating the first embodiment of the present invention and illustrating an example of priority control information managed by the global priority manager;

FIG. 19 is a flowchart illustrating the first embodiment of the present invention and illustrating an example of the system configuration information collection computing of the global priority manager;

FIG. 20A is the first half section of a flowchart illustrating the first embodiment of the present invention and illustrating an example of computing in which the global priority manager notifies the priority of communication to the local priority manager;

FIG. 20B is the latter half section of the flowchart illustrating the first embodiment of the present invention and illustrating the example of the computing in which the global priority manager notifies the priority of communication to the local priority manager;

FIG. 21 is a flowchart illustrating the first embodiment of the present invention and illustrating an example of computing in which the local priority manager sets the priority of communication;

FIG. 22 is a block diagram illustrating the first embodiment of the present invention and at the completion of the execution of the task;

FIG. 23 is a block diagram illustrating the first embodiment of the present invention and illustrating an example in which task execution start information is relayed;

FIG. 24 is a block diagram illustrating the first embodiment of the present invention and illustrating an example in which the priority control information is set to the NIC and the priority control information is set to the network switch;

FIG. 25 is a block diagram illustrating the first embodiment of the present invention and illustrating an example of partial data when the communication priority control is performed;

FIG. 26 is a diagram illustrating the first embodiment of the present invention and illustrating an example of a screen that represents the communication state of the tasks being executed;

FIG. 27 is a sequence diagram illustrating a second embodiment of the present invention and illustrating an example of data priority control performed in the distributed computing system;

FIG. 28 is a diagram illustrating the second embodiment of the present invention and illustrating an example of request information transmitted by the worker of the distributed computing system that is the request source of processed data;

FIG. 29 is a diagram illustrating the second embodiment of the present invention and illustrating an example of request information transmitted by the local priority manager;

FIG. 30 is a diagram illustrating the second embodiment of the present invention and illustrating an example of processed data in which the worker of the distributed computing system that is the request destination of the processed data responds to information requested by the local priority manager;

FIG. 31 is a diagram illustrating the second embodiment of the present invention and illustrating an example of additional request information that the worker of the distributed computing system that is the request source of the processed data notifies to the worker of the distributed computing system that is the request destination of the processed data after the computing of response data with respect to information requested by the local priority manager;

FIG. 32 is a diagram illustrating the second embodiment of the present invention and illustrating an example of information about the time from the reception of the data size transmitted to the worker of the distributed computing system that is the request source of the processed data and the response data having a size smaller than the data requested by the worker of the distributed computing system that is the request source of the processed data, to the reception of the additional request information;

FIG. 33 is a block diagram illustrating the second embodiment of the present invention and illustrating an example in which the processed data is transmitted between the workers of the distributed computing system;

FIG. 34 is a block diagram illustrating the second embodiment of the present invention and illustrating an example in which the measurement data of the computing time of the task is collected; and

FIG. 35 is a block diagram illustrating the second embodiment of the present invention and illustrating an example in which the priority control information is set to the NIC and the priority control information is set to the network switch.

### DESCRIPTION OF EMBODIMENTS

Embodiments of the present invention will be described below in detail with reference to the drawings.

### The Overview of a System Configuration

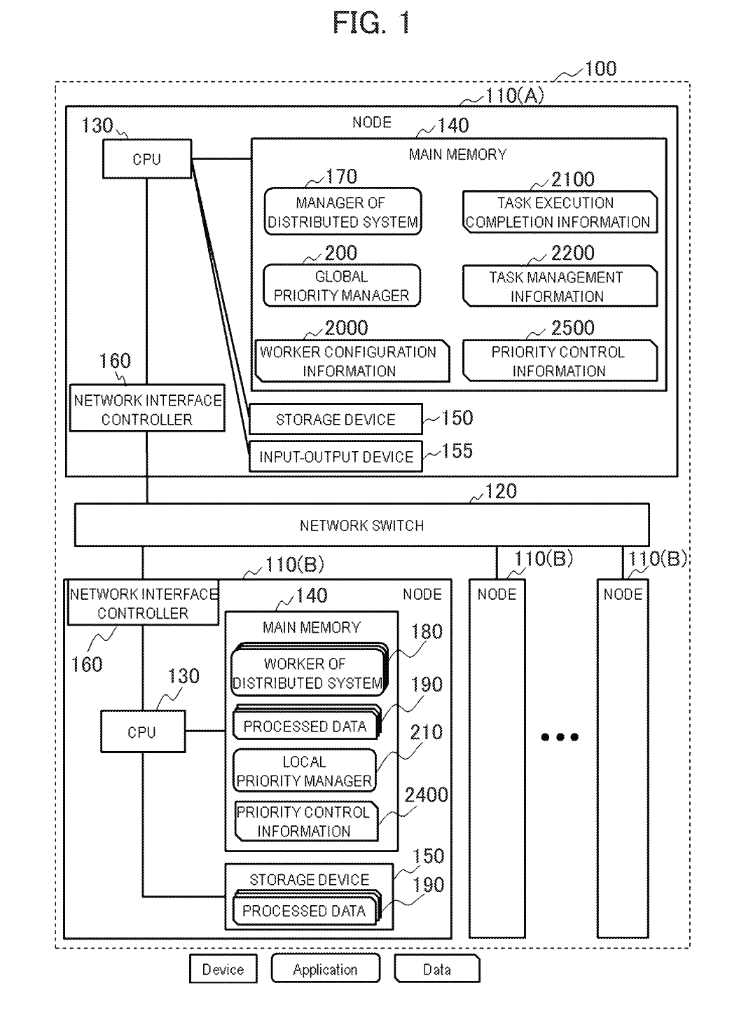

FIG. 1 is a block diagram illustrating an example of a distributed computing system of the present invention. A distributed computing system 100 of FIG. 1 includes nodes 110(A) and 110(B) and a network switch 120. At this time, the nodes 110(A) and 110(B) can include a computer, such as a physical machine and a virtual machine, and in addition, the network switch 120 can include a network device, such as a physical switch and a virtual switch.

Each of the nodes 110(A) and 110(B) includes a CPU (Central Processing Unit) 130, a main memory 140, a storage device 150, and a network interface controller (NIC) 160. The node 110 is connected to other nodes via the network switch 120. It should be noted that the node 110(A) has an input-output device 155 including an input device and a display.

In FIG. 1, the management node that manages the distributed computing system 100 is indicated by the reference numeral 110(A), and the management software operated on the node 110(A) is called a manager of the distributed computing system (management unit) 170. In addition, in the distributed computing system 100, the node that actually computes the request of a user is indicated by the reference numeral 110(B), and the computing software operated on the node 110(B) is called a worker of the distributed computing system 180. In the first embodiment, the example is illustrated in which the manager of the distributed computing system 170 and the worker of the distributed computing system 180 are executed on the different nodes, but the present invention is not limited to this.

In addition, the node 110(A) and the node 110(B) may include one or a plurality of nodes 110(A) and one or a plurality of nodes 110(B), respectively, and a plurality of workers of the distributed computing system 180 may be operated on one node 110(B).

On the main memory 140 of the node 110(A), worker configuration information 2000, task execution completion information 2100, task management information 2200, and priority control information 2500 are stored.

Each functioning unit of the manager of the distributed computing system 170 and a global priority manager 200 of the node 110(A) is loaded as a program onto the main memory 140.

The CPU 130 is operated as a functioning unit providing the predetermined function by performing computing according to the program of each functioning unit. For example, the CPU 130 functions as the manager of the distributed computing system 170 by performing the computing according to the program of the manager of the distributed computing system. This is ditto for other programs. Further, the CPU 130 is operated as a functioning unit providing each function of a plurality of computing executed by each program. The computer and the computer system are a device and a system including these functioning units, respectively.

The information of the program, the table, and the like achieving each function of the node 110(A) can be stored on the storage device 150. The storage device 150 includes a storage device, such as a nonvolatile semiconductor memory, a hard disk drive, and an SSD (Solid State Drive), or a computer-readable non-temporary data storage medium, such as an IC card, an SD card, and a DVD.

In FIG. 1, processed data 190 represents data obtained as a result of the computing by the worker of the distributed computing system 180. The processed data 190 is stored on the main memory 140 or on the storage device 150 of the node 110(B).

On the main memory 140 of the node 110(B), the processed data 190 and priority control information 2400 are stored.

Each functioning unit of the worker of the distributed computing system 180 and a local priority manager 210 of the node 110(B) is loaded as a program onto the main memory 140.

The CPU 130 of the node 110(B) is operated as a functioning unit providing the predetermined function by performing computing according to the program of each functioning unit. For example, the CPU 130 functions as the worker of the distributed computing system 180 by performing the computing according to the program of the worker of the distributed computing system. This is ditto for other programs.

### The Overview of Shuffle Computing

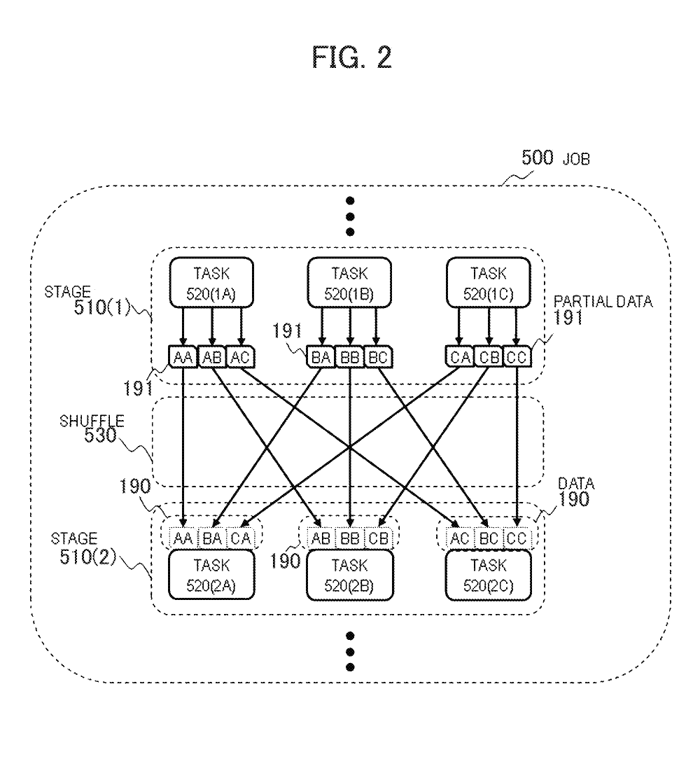

FIG. 2 is a diagram illustrating an example of shuffle 530 in the distributed computing system 100. In the distributed computing system 100, the manager of the distributed computing system 170 of the node 110(A) partitions a job 500 that is the request of the user into a plurality of computing units called tasks 520(1A) to 520(1C), and a plurality of workers of the distributed computing system 180 of the nodes 110(B) execute those tasks 520 in parallel, thereby computing the job 500 at high speed.

The respective tasks 520(1A) to 520(1C) belong to a group called a stage 510(1), and basically, the tasks 520(1A) to 520(1C) in the same stage 510(1) perform the same computing with respect to different data.

It should be noted that when all the tasks are designated, they are indicated by the reference numeral 520 omitting “(” and thereafter. In addition, this is ditto for the reference numerals of other components.

In addition, except for the task 520 executed first, in principle, each task 520 is computed with the input of the processed data 190 that is the execution result of the previous stage 510. The processed data 190 includes one or more partial data 191 generated by the task 520 in the previous stage 510, and until the obtaining of all the necessary partial data 191, the execution of the task 520 in the next stage 510 is not performed.

For example, in a task 520(2A) belonging to a stage 510(2) of FIG. 2, the processed data 190 necessary for the execution includes partial data 191(AA), 191(BA), and 191(CA). Each of these partial data 191 is a portion of the execution result of each of the tasks 520(1A), 520(1B), and 520(1C) in the previous stage 510(1), and the partial data 191 is obtained from the node 110 in which each of the tasks 520(1A), 520(1B), and 520(1C) in the previous stage 510(1) has been executed.

In this way, the computing in which the data to be computed by the task 520 in the following stage 510 is configured by shuffling the partial data 191 of the plurality of tasks 520 in the preceding stage 510 is called the shuffle 530.

### The Problem of a Conventional Shuffle Computing

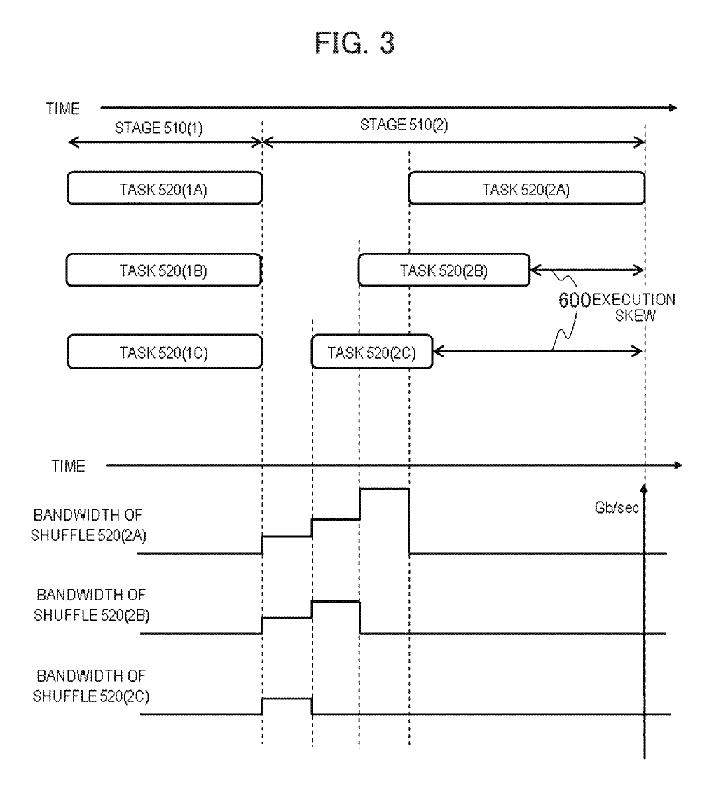

FIG. 3 is a diagram illustrating a conventional example and illustrating an example in which skew occurs during the execution time due to the difference in the data size of each task 520. In the illustrated example, an example is illustrated in which the size of the processed data 190 of the task 520(2A) is large, and the size of the processed data 190 of the task 520(2C) is small.

The upper section in the drawing represents the execution start time and the completion time of the tasks 520, and the lower section in the drawing represents the effective transfer bandwidths of the processed data transferred by the shuffle. In FIG. 3, when the respective tasks 520 in the stage 510(1) are completed, the tasks 520(2A), 520(2B), and 520(2C) are started to be shuffled at the same time, and the respective tasks 520 unlimitedly use the network bandwidths to transfer the processed data 190 (the partial data 191).

At this time, the shuffle of the task 520(2C) in which the size of the processed data 190 is the smallest is completed first to start the task execution. Thereafter, the shuffle is completed in the order of the tasks 520(2B) and 520(2A), but in the task 520(2A) in which the shuffle is completed last, the task execution time is extended because the amount of data computed is large, so that the delay becomes further greater.

On the other hand, the computing of the task 520(2C) in which the size of the processed data is the smallest is completed early, and the task 520(2C) waits for the completion of another task 520(2A) in the same stage 510(2) for a long time. The waiting time due to the variation in the execution time occurring between the tasks is called skew 600, and when the skew 600 is great, the efficiency of the distributed computing is lowered, so that the execution time of the entire job 500 becomes longer.

### The Solution Approach of Present Invention

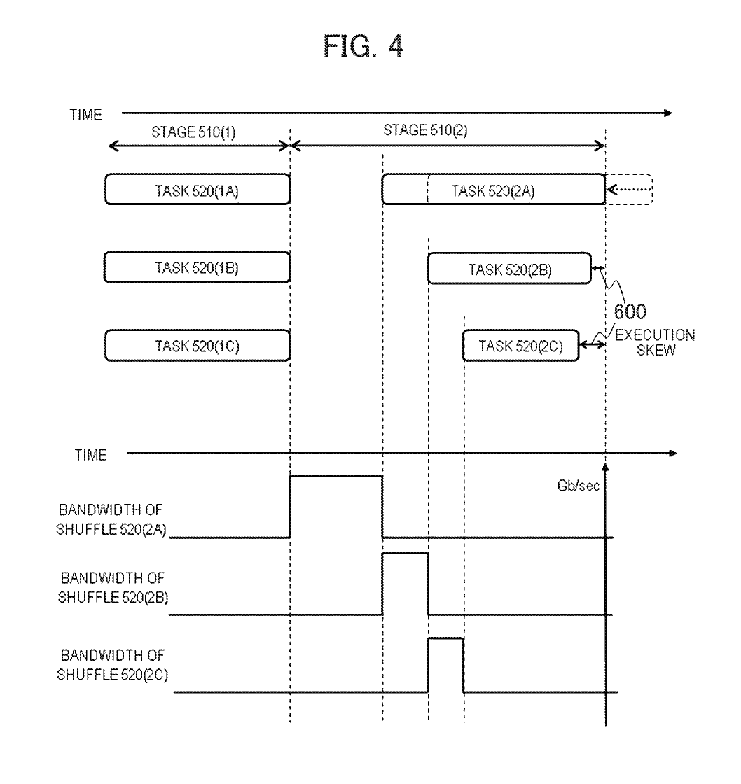

FIG. 4 is a diagram illustrating an example in which the variation in the execution time of each task 520 in the distributed computing system 100 is relieved by the communication priority control of the shuffle 530.

To solve the above problem, in FIG. 4, the shuffle of the task 520(2A) in which the execution time is long (the data size is the largest) is transferred on a priority basis to start the execution of the task early, so that the skew 600 is reduced, and the execution time of the entire job 500 is shortened.

The transfer of the processed data 190 of the task 520(2A) in which the data size is large is prioritized, so that the shuffle time of the tasks 520(B) and 520(C) is extended, but due to the difference in the data size of each task 520, it is assumed that the execution time of those tasks is short, and as a result, the skew 600 is reduced and the execution time can be shortened.

It should be noted that it is assumed that the physical standards in the network of the following embodiments are Ethernet, but the physical standards maybe InfiniBand (that is the trademark or service mark of InfiniBand Trade Association), and may be other standards, and in addition, it is assumed that the network protocol is TCP/IP, but may be RDMA (Remote Direct Memory Access) or other protocols.

### First Embodiment

### The Functions Used in the Present Invention

The global priority manager 200 of the node 110(A) illustrated in FIG. 1 has the following functions related to all of the management node 110(A) and the distributed computing system 100, among the functions of controlling priority with respect to communication between the nodes 110 of the distributed computing system 100.

Function 1-1. The function that relays transferred data from the worker of the distributed computing system 180 of the node 110(B) to the manager of the distributed computing system 170, and collects the contents of the transferred data.

Function 1-2. The function that obtains, from the local priority manager 210, the information related to the task 520 that the manager of the distributed computing system 170 of the node 110(A) assigns to the worker of the distributed computing system 180.

Function 1-3. The function that decides the priority of communication set to one or more network switches 120 present in the distributed computing system 100 and the NIC 160 mounted on each node 110 based on the information collected by the function 1-1 and the function 1-2 and the like.

Function 1-4. The function that transmits the information in order for the local priority manager 210 to perform the communication priority control of the NIC 160 mounted on the node 110(B) based on the execution result of the function 1-3.

Function 1-5. The function that actually sets the priority of communication to the network switch 120 based on the execution result of the function 1-3.

In the first embodiment, it is assumed that the global priority manager 200 is operated on the same node 110(A) as the manager of the distributed computing system 170, but the present invention is not limited to this.

In addition, the local priority manager 210 has the following functions related to the computing node 110(B), among the functions of controlling the priority of communication between the nodes of the distributed computing system 100.

Function 2-1. The function that relays transferred data from the manager of the distributed computing system 170 to the worker of the distributed computing system 180, and collects the contents thereof.

Function 2-2. The function transmits the information related to the task 520 assigned to the worker of the distributed computing system 180 to the global priority manager 200.

Function 2-3. The function that obtains, from the global priority manager 200, the information in order for the local priority manager 210 to perform the communication priority control of the NIC 160 mounted on the node 110(B) taken charge of by the local priority manager 210.

Function 2-4. The function that actually sets the priority of communication to the NIC 160 of the node 110(B) based on the result obtained from the function 2-3.

In this embodiment, it is assumed that the local priority manager 210 is operated on the same node 110(B) as the worker of the distributed computing system 180, but the present invention is not limited to this.

Examples of computing performed in the distributed computing system 100 of the first embodiment will be described below.

### The Management of the System Configuration

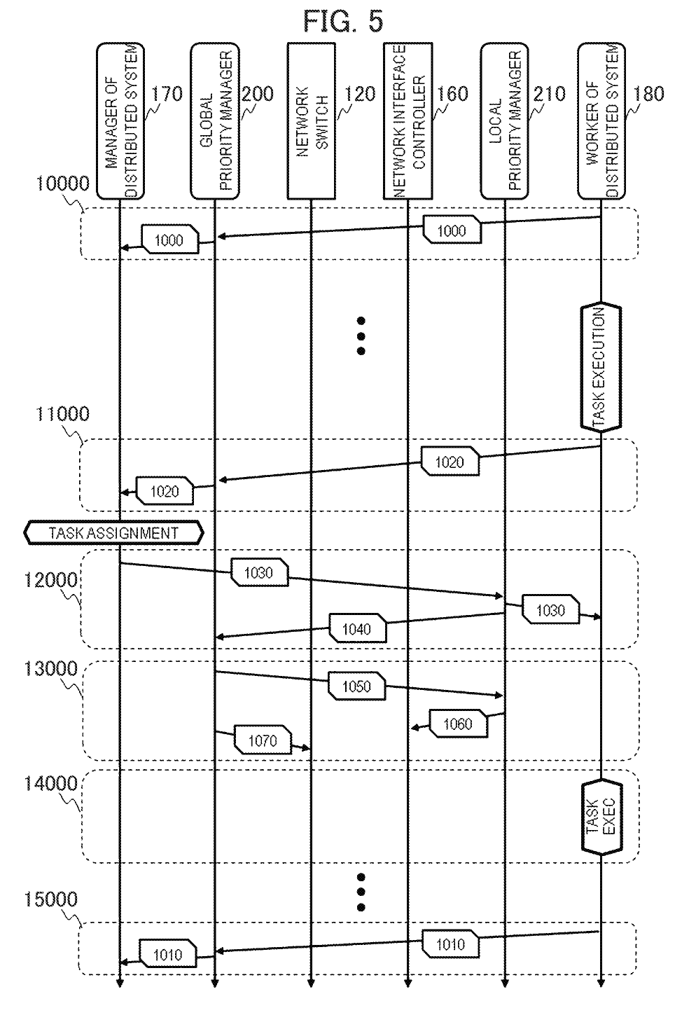

FIG. 5 is a sequence diagram illustrating an example of the data priority control performed in the distributed computing system of the first embodiment.

First, to obtain the configuration of the distributed computing system 100, the global priority manager 200 refers to the contents of participation information 1000 and separation information 1010 from the worker of the distributed computing system 180 when relaying the participation information 1000 and the separation information 1010. The participation information 1000 is information transmitted to the manager of the distributed computing system 170 when the worker of the distributed computing system 180 participates in the distributed computing system 100 (a procedure 10000). The separation information 1010 is information transmitted to the manager of the distributed computing system 170 when the worker of the distributed computing system 180 separates from the distributed computing system 100 (a procedure 15000).

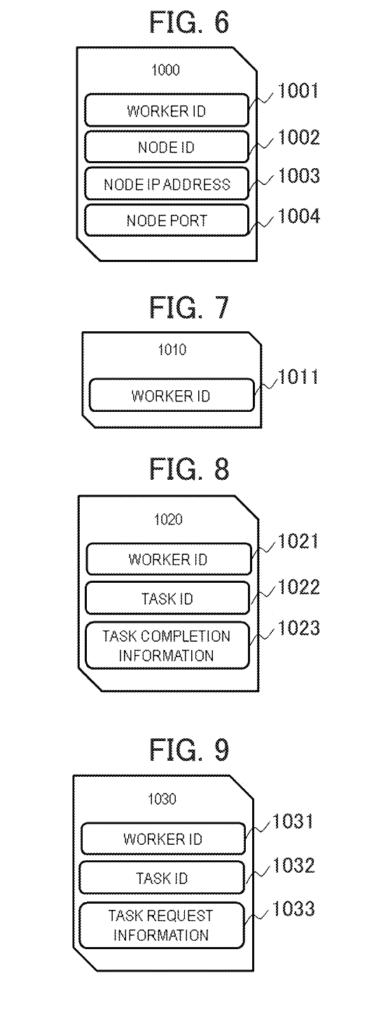

FIG. 6 is a diagram illustrating an example of the participation information 1000. As illustrated in FIG. 6, for example, the participation information 1000 to the distributed computing system 100 includes a worker ID 1001 identifying each worker of the distributed computing system 180, a node ID 1002 for identifying the node 110 on which the worker of the distributed computing system 180 is operated, an IP address 1003 representing the IP address of the node 110, and a port number 1004 that the worker of the distributed computing system 180 uses for the data transfer.

FIG. 7 is a diagram illustrating an example of the separation information 1010. The separation information 1010 stores, for example, a worker ID 1011.

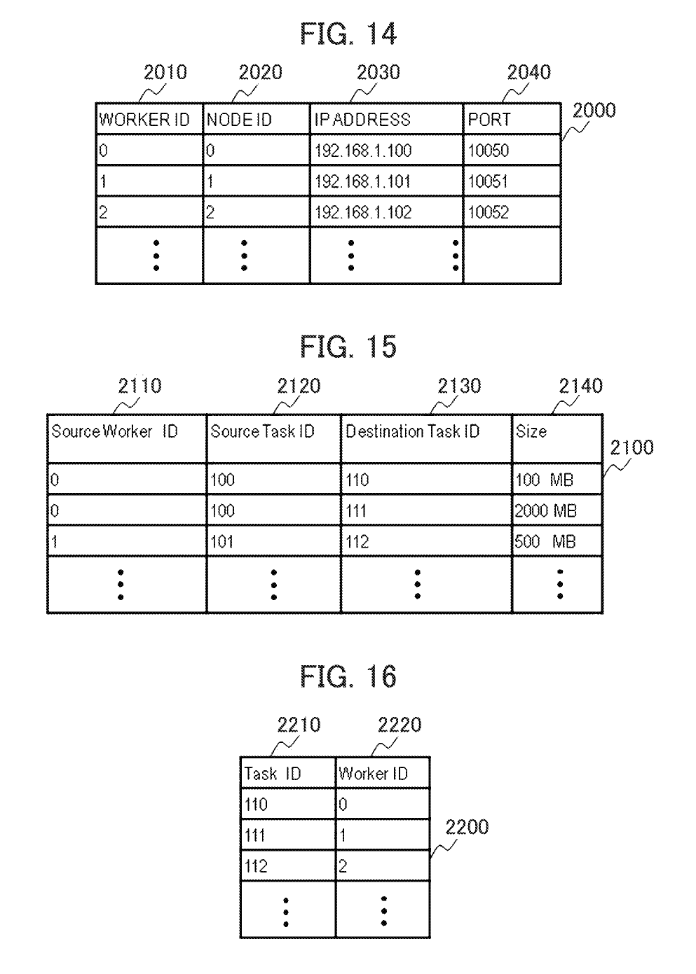

FIG. 14 is a diagram illustrating an example of the worker configuration information 2000 managed by the global priority manager 200. The worker configuration information 2000 includes a worker ID 2010, a node ID 2020 and an IP address 2030 and a port number 2040 of the node 110 in one entry.

When receiving the participation information 1000 from the worker of the distributed computing system 180, the global priority manager 200 adds the row managing the worker of the distributed computing system 180 to the worker configuration information 2000, and when receiving the separation information 1010, the global priority manager 200 deletes the row managing the worker of the distributed computing system 180 from the worker configuration information 2000.

It should be noted that the global priority manager 200 transfers, on an as-is basis, the participation information 1000 and the separation information 1010 of the worker of the distributed computing system 180 relayed by the global priority manager 200 to the manager of the distributed computing system 170. The manager of the distributed computing system 170 can transparently compute the participation information 1000 and the separation information 1010.

### The Obtaining of the Information of the Processed Data in the Previous Stage

A procedure 11000 of FIG. 5 represents computing in which the worker of the distributed computing system 180 completes the computing of the task 520, and transmits a completion notification 1020 (see FIG. 8) to the manager of the distributed computing system 170.

FIG. 8 is a diagram illustrating an example of the completion notification 1020. The completion notification 1020 includes an ID 1021 of the worker 180, an ID 1022 of the task 520, and task completion information 1023, such as the processed data 190 and the partial data 191 at the completion of the task 520.

The global priority manager 200 relays and refers to the computing completion notification information of the task 520 transmitted from the worker of the distributed computing system 180, and manages the data transfer information to the next stage 510 by the task execution completion information 2100 illustrated in FIG. 15.

FIG. 15 is a diagram illustrating an example of the task execution completion information 2100 in which the global priority manager 200 relays and refers to the computing completion notification information of the task 520 transmitted from the worker of the distributed computing system 180, and manages the data transfer information to the next stage 510.

The task execution completion information 2100 includes, for example, a transfer source worker ID 2110 of the worker of the distributed computing system 180 that has executed the task 520, a transfer source task ID 2120 for identifying the task 520 that is a data transfer source, a transfer destination task ID 2130 storing the destination transferring the processed data 190 obtained as a result of the execution of the task 520, and a size 2140 of the processed data 190 in one entry.

The global priority manager 200 allows the information of the task execution completion information 2100 to be the hint deciding the priority of communication when the next stage 510 is executed. It should be noted that the global priority manager transfers, on an as-is basis, the relayed completion notification 1020 to the manager of the distributed computing system 170, so that the completion notification 1020 can be transparently computed in the distributed computing system 100.

The relation of the correspondence with the functions

The above procedure 10000 and procedure 11000 are achieved by the function 1-1. of the global priority manager 200. The computing executed by the global priority manager 200 achieving the function 1-1. is illustrated in FIG. 19. FIG. 19 is a flowchart illustrating an example of the computing performed by the global priority manager 200. This computing is executed when the global priority manager 200 receives data from the worker of the distributed computing system 180.

In a procedure S100, the global priority manager 200 receives some data from the worker of the distributed computing system 180 to the manager of the distributed computing system 170.

In a procedure S102, the global priority manager 200 determines the contents of the received data.

When the received data is the participation information 1000 in which the worker of the distributed computing system 180 participates in the distributed computing system 100, the global priority manager 200 goes to a procedure S104. When the received data is the separation information 1010 in which the worker of the distributed computing system 180 separates from the distributed computing system 100, the global priority manager 200 goes to a procedure S106. When the received data is the completion notification 1020 of the task 520 assigned to the worker of the distributed computing system 180, the global priority manager 200 goes to a procedure S108.

In the procedure S104, the global priority manager 200 adds the information of the worker of the distributed computing system 180 to the worker configuration information 2000 representing the configuration of the distributed computing system 100, and goes to a procedure S114.

In the procedure S106, the global priority manager 200 deletes the information of the worker of the distributed computing system 180 from the worker configuration information 2000 representing the configuration of the distributed computing system 100, and goes to the procedure S114.

In the procedure S108, the global priority manager 200 determines whether or not the task execution completion information 2100 related to the next stage 510 using the processed data 190 of the task 520 has been generated. When the task execution completion information 2100 has not been generated, the global priority manager 200 goes to a procedure S110, and when the task execution completion information 2100 has been generated, the global priority manager 200 goes to a procedure S112.

In the procedure S110, the global priority manager 200 generates the task execution completion information 2100 related to the stage 510.

In the procedure S112, the global priority manager 200 adds the information of the completion notification 1020 of the task 520 to the task execution completion information 2100 related to the stage.

In the procedure S114, the global priority manager 200 transfers the data to the manager of the distributed computing system 170.

By the above computing, in the node 110(A), when the data is received from the worker of the distributed computing system 180, the worker configuration information 2000 or the task execution completion information 2100 is updated.

### The Obtaining of Task Assignment Information

A procedure 12000 illustrated in FIG. 5 represents computing in which the manager of the distributed computing system 170 assigns the task 520 to the worker of the distributed computing system 180 of the node 110(B). Here, first, the local priority manager 210 relays and refers to assignment notification information 1030 of the task 520 transmitted from the manager of the distributed computing system 170 to the worker of the distributed computing system 180.

As illustrated in FIG. 9, the assignment notification information 1030 includes an ID 1031 of the worker of the distributed computing system 180, an ID 1032 assigned to the task 520, and request information 1033 assigning the task 520 actually computed. It should be noted that the request information 1033 can include the data size of the task 520 or the data size of the partial data 191.

The local priority manager 210 obtains shuffle information 1040 that is the hint of the communication priority control (information, such as the data size) from the inside of the relayed assignment notification information 1030, and transfers the shuffle information 1040 to the global priority manager 200 of the node 110(A).

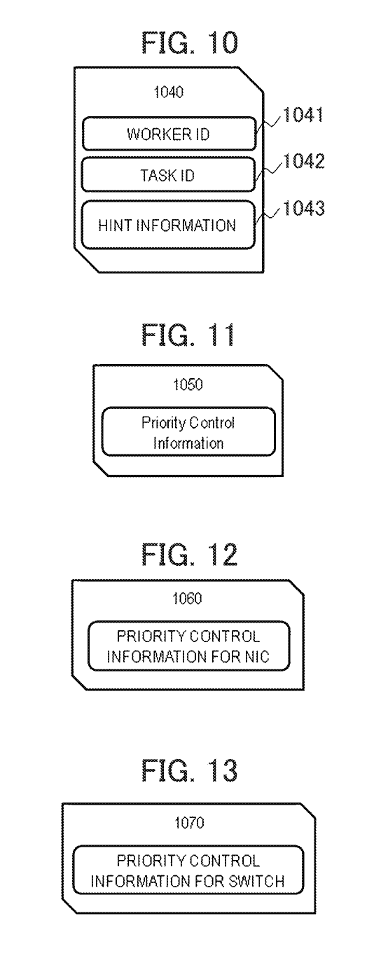

FIG. 10 is a diagram illustrating an example of the shuffle information 1040 in order for the local priority manager 210 to provide, to the global priority manager 200, the information related to the shuffle 530 of the task 520 in which the local priority manager 210 allows the worker of the distributed computing system 180 to execute the task 520. As illustrated in FIG. 10, the shuffle information 1040 includes, for example, a worker ID 1041, a task ID 1042, and hint information 1043.

The local priority manager 210 obtains the data size of the task 520 (or the partial data 191) from the request information 1033 of the relayed assignment notification information 1030, and generates the shuffle information 1040.

The global priority manager 200 generates the task management information 2200 as illustrated in FIG. 16 for each stage 510 based on the shuffle information 1040 notified from the local priority manager 210.

FIG. 16 is a diagram illustrating an example of the task management information 2200. The task management information 2200 includes a task ID 2210 and a worker ID 2220 in one entry, and allows the worker of the distributed computing system 180 on which the task 520 is computed to be referred to.

The local priority manager transfers, on an as-is basis, the assignment notification information 1030 to the worker of the distributed computing system 180, so that the assignment notification information 1030 can be transparently computed in the distributed computing system 100.

In addition, this procedure is achieved by the function 1-2 of the global priority manager 200 and the functions 2-1 and 2-2 of the local priority manager 210.

### The Decision and Setting of the Priority

A procedure 13000 of FIG. 5 represents computing in which the global priority manager 200 and the local priority manager 210 set the priority of communication for the network switch 120 and the priority of communication for the NIC 160, respectively.

First, the global priority manager 200 receives the shuffle information 1040 including the data size from each node 110(B) computing the task 520. It should be noted that in FIG. 5, the example is illustrated in which the shuffle information 1040 is received from one worker of the distributed computing system 180, but the same computing is performed to other workers of the distributed computing system 180 computing the tasks 520.

The global priority manager 200 decides the priority of communication for each task 520 based on each shuffle information 1040. The global priority manager 200 gives data including priority control information 1050 related to the priority of communication as illustrated in FIG. 11 to the local priority manager 210 based on the decided priority for each task 520.

Thereafter, the local priority manager 210 sets setting information 1060 of the priority of communication as illustrated in FIG. 12 to the NIC 160. In addition, the global priority manager 200 sets setting information 1070 of the priority of communication as illustrated in FIG. 13 to the network switch 120 based on the decided priority.

By the above computing, the priority of communication for each task 520 decided by the global priority manager 200 is set to the network switch 120 and the NIC 160 of the node 110(B). Then, between the nodes 110(B), the transfer of the processed data 190 assigned to the task 520 is started. The network switch 120 and the NIC 160 of the node 110(B) to which the priority is set execute the priority control according to the priority for each processed data 190. It should be noted that the priority control can be achieved by the predetermined control, such as the control of the bandwidth and the transfer order.

In the first embodiment, an example is illustrated in which the transfer is performed sequentially starting from the processed data 190 (the partial data 191) of the task 520 having high priority, and the execution is started sequentially starting from the task 520 in which the transfer of the processed data 190 has been completed.

The decision and notification of the priority of communication, and the setting of the priority of communication for the network switch

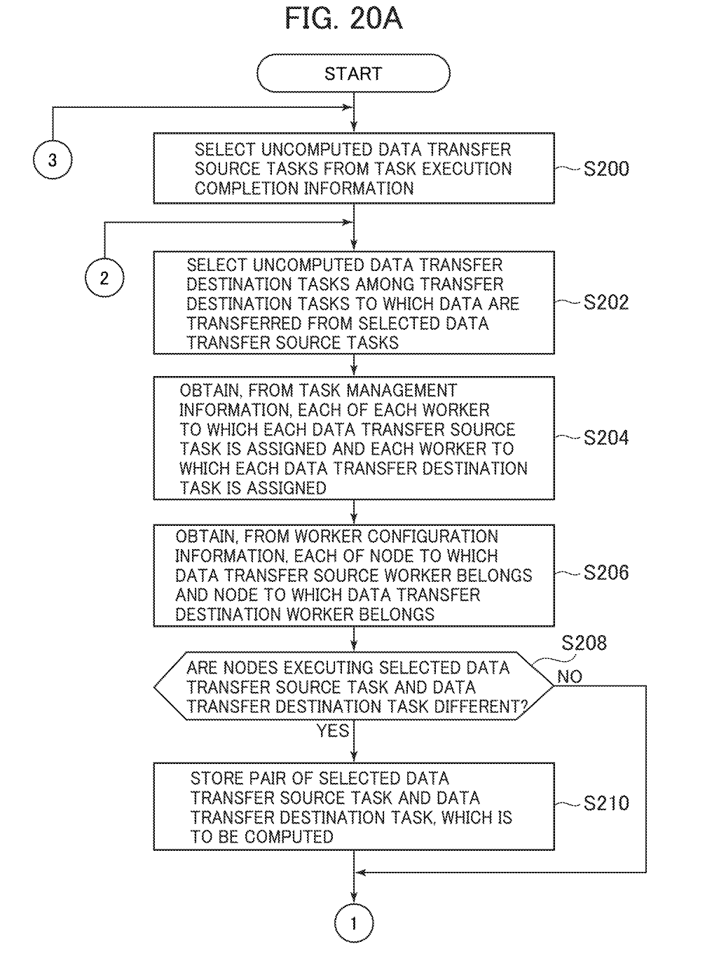

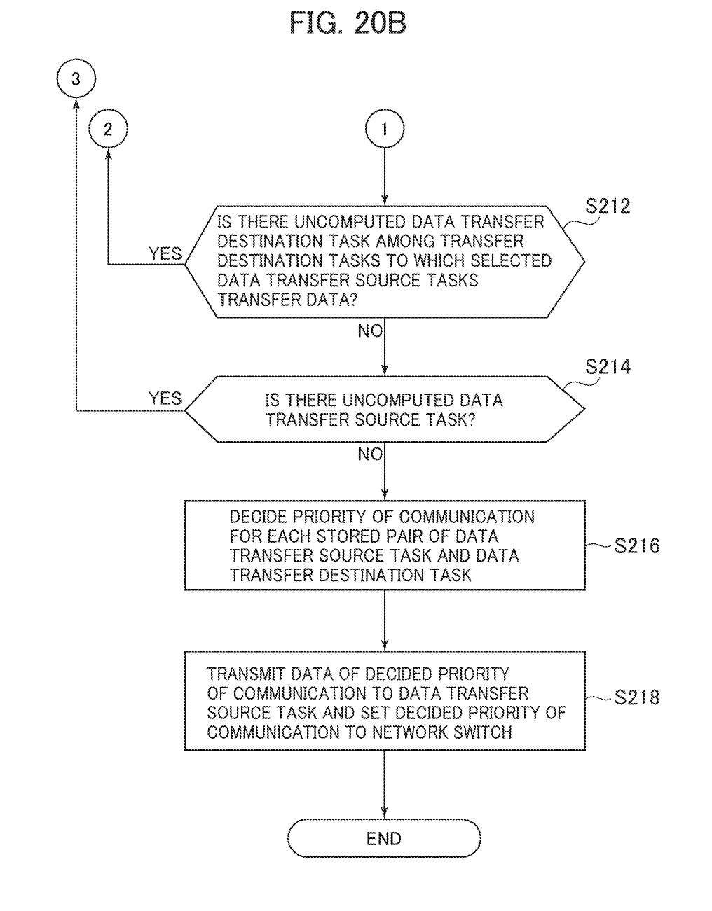

Hereinafter, referring to the flowchart of FIGS. 20A and 20B, computing is illustrated in which the global priority manager 200 gives the control information to the local priority manager 210 that is the transfer source of the processed data 190. FIGS. 20A and 20B respectively illustrate the first half section and the latter half section of the flowchart illustrating an example of computing for achieving the function 1-3 of the global priority manager 200.

In a procedure S200, the global priority manager 200 selects the uncomputed data transfer source task IDs 2120 from the task execution completion information 2100. In a procedure S202, the global priority manager 200 selects the uncomputed transfer destination task IDs 2130, among the transfer destination task IDs 2130 to which the data are transferred from the selected transfer source task IDs 2120.

In a procedure S204, the global priority manager 200 uses the task management information 2200 to obtain each of the worker ID 2220 of each worker of the distributed computing system 180 to which each data transfer source task is assigned and the worker ID 2220 of each worker of the distributed computing system 180 to which each data transfer destination task is assigned.

In a procedure S206, the global priority manager 200 uses the worker configuration information 2000 to obtain the node ID 2020 to which the data transfer source worker belongs and the node ID 2020 to which the data transfer destination worker belongs.

In a procedure S208, the global priority manager 200 determines whether or not the node ID 2020 of the data transfer destination task and the node ID 2020 of the data transfer destination task are different. When the determination result shows non-matching, the global priority manager 200 goes to a procedure S210, and when the determination result shows matching, the global priority manager 200 goes to a procedure S212.

In the procedure S210, the global priority manager 200 stores a pair of the information of the selected data transfer source task and the information of the selected data transfer destination task, which is to be computed. In the procedure S212, when there is the pair of the selected data transfer source task and the transfer destination task to which the transfer source task transfers the data, to which the computing is unapplied, the global priority manager 200 returns to the procedure S202. On the other hand, when the computing is completed with respect to all the transfer destination tasks, the global priority manager 200 goes to a procedure S214.

In the procedure S214, when there is the uncomputed data transfer source task, the global priority manager 200 returns to the procedure S200. When the computing is completed with respect to all the data transfer source tasks, the global priority manager 200 goes to a procedure S216.

In the procedure S216, the global priority manager 200 decides the priority of communication for the pair of the data transfer source task and the data transfer destination task, the pair being stored to be computed, from the hint information 1043 related to the shuffle. The hint information 1043 is, for example, the data size of each of the tasks 520 (or the partial data 191) and the like.

It should be noted that the priority of the first embodiment illustrates the example in which the transfer is executed sequentially starting from the data having high priority, but the present invention is not limited to this. For example, the bandwidth of the network switch 120 may be assigned according to the priority.

In a procedure S218, the global priority manager 200 notifies the information of the decided priority of communication to the local priority manager 210 of the node 110 of the data transfer source task. In addition, the global priority manager 200 sets the decided priority of communication to the network switch 120.

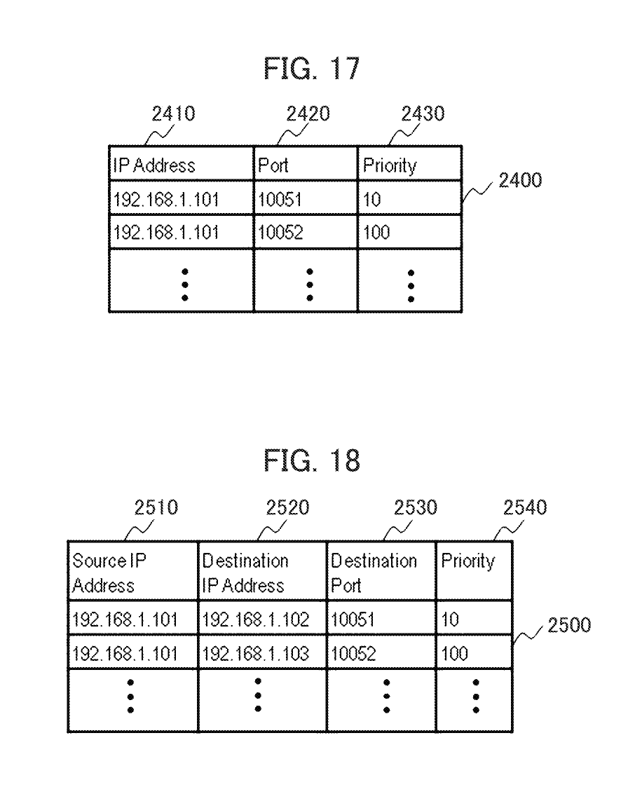

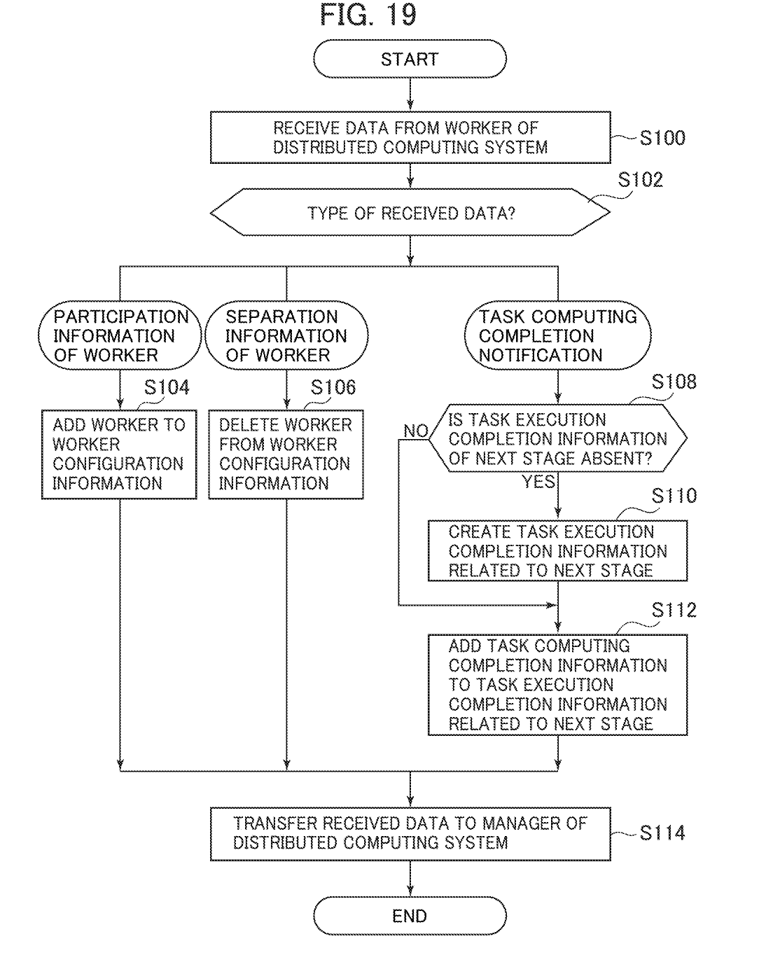

The priority control information notified in the procedure S218 includes, for example, the information illustrated in the priority control information 2400 of FIG. 17. FIG. 17 is a diagram illustrating an example of the priority control information 2400 managed by the local priority manager 210. The priority control information 2400 includes an IP address 2410 storing the destination of the transfer destination task 520, an IP port 2420 storing the port of the transfer destination task 520, and priority 2430 for the task 520 in one entry.

It should be noted that when the global priority manager 200 gives the control information to the local priority manager 210 that is the transfer destination, the data transfer destination task and the data transfer source task are replaced in the flowchart of FIGS. 20A and 20B.

When receiving the communication priority control information related to the task 520 computed by the node 110(B), transmitted from the global priority manager 200 by the computing of FIGS. 20A and 20B, the local priority manager 210 sets the communication priority control information to the task, the NIC 160, and the NIC driver (not illustrated) of the node 110.

FIG. 18 is a diagram illustrating an example of the priority control information 2500 managed by the global priority manager.

In the priority control information 2500, one entry is configured from a transmission source IP address 2510 of the task 520 that is the transfer source of the partial data 191, a destination IP address 2520 of the task 520 that is the transfer destination of the partial data 191, a destination port 2530 storing the port number of the transfer destination task 520, and priority 2540.

The setting of the priority of communication for the NIC

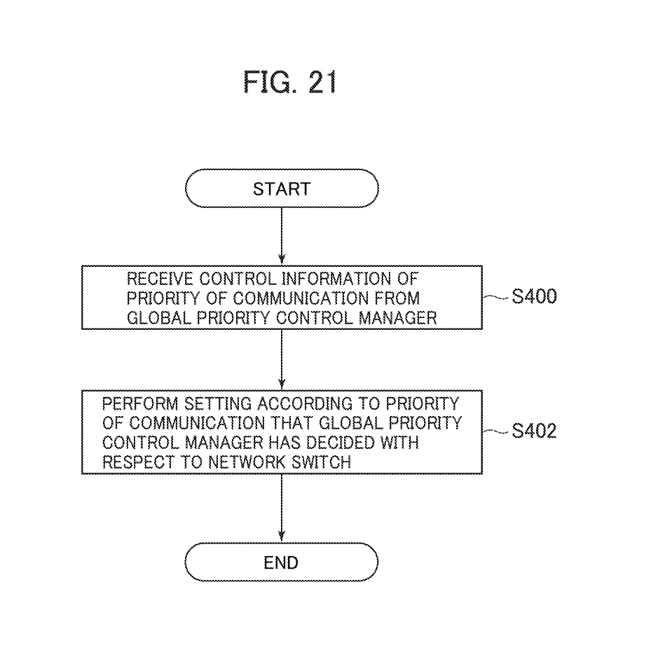

The setting computing of the priority of communication for the local priority manager 210 is illustrated in the flowchart of FIG. 21.

In a procedure S400, the local priority manager 210 receives the control information of the priority of communication from the global priority manager 200.

In a procedure S402, the local priority manager 210 performs the setting according to the received priority of communication to the NIC 160. In addition, the local priority manager 210 updates the priority control information 2400 based on the received control information of the priority of communication.

### The Decision Method of the Priority

As one method for deciding the priority of communication 2540 performed by the global priority manager 200, a method is considered in which as the amount of data transferred of a pair of tasks 520 is larger, the priority is increased. However, the present invention is not limited to this decision method. It should be noted that as the value of the priority 2540 of the priority control information 2500 is larger, the priority for the task 520 is higher.

### The Execution of the Task According to the Priority

A procedure 14000 of FIG. 5 represents the state of the execution of the task 520 under the environment of the network switch 120 and the node 110(B) to which the priority of communication is set. Although not illustrated in the sequence diagram, the transfer of the data along the priority of communication that is set to the network switch 120 and the NIC 160 is performed.

### Examples of Computing

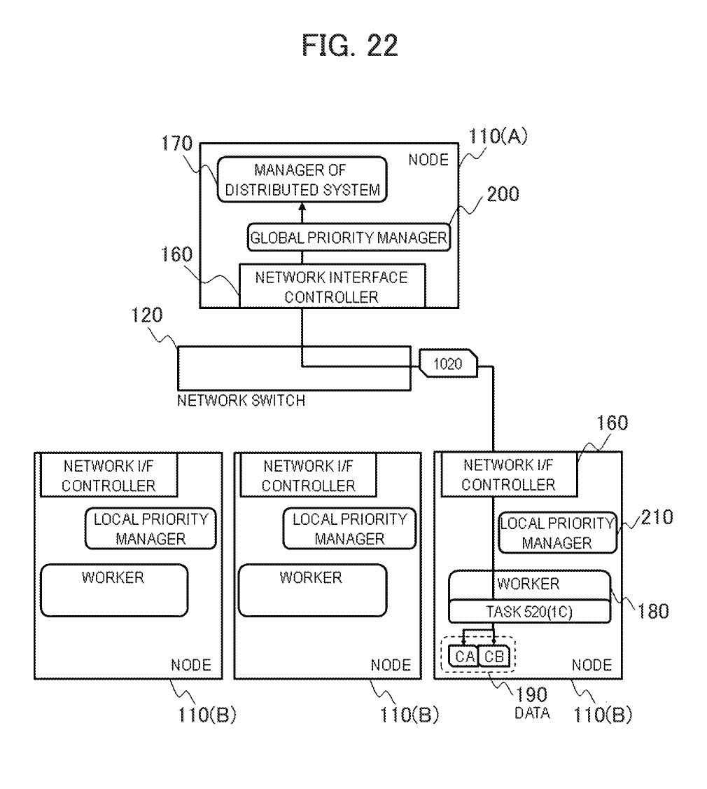

The flow of the data between the nodes 110 when the procedure 12000 and the procedure 13000 of FIG. 5 are executed will be described with reference to FIGS. 22 to 25 in which the description of the moving state of the data is added to the configuration of FIG. 1. It should be noted that to simplify the description, the flow of the data will be described by noting only computing in which the task 520(1C) of FIG. 2 transfers the partial data 191 to the tasks 520(2A) and 520(2B).

FIG. 22 is a block diagram when the computing of the task 520(1C) is completed. In the node 110(B) that has executed the task 520(1C), the partial data 191(CA) and 191(CB) that are the computing results of the task 520(1C) are generated.

The task 520(1C) transmits the completion notification 1020 to the manager of the distributed computing system 170. At this time, in the node 110(A) in which the manager of the distributed computing system 170 is executed, the global priority manager 200 actually receives the completion notification 1020.

The global priority manager 200 obtains the information related to the processed data 190 from the received completion notification 1020 (the task completion information 1023), and transmits the completion notification 1020 to the manager of the distributed computing system 170.

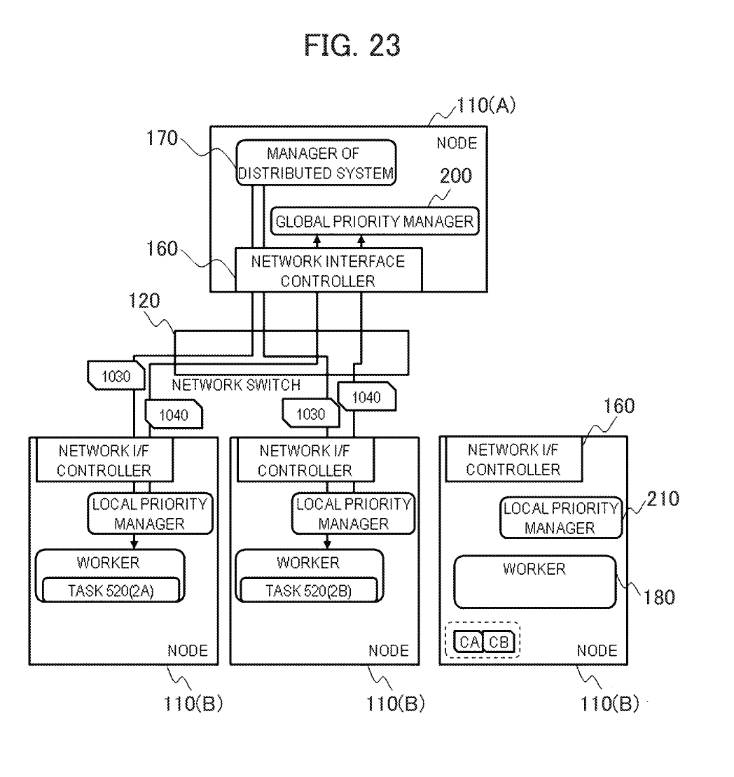

FIG. 23 is a computing block diagram when the manager of the distributed computing system 170 assigns the tasks 520(2A) and 520(2B) in the next stage to the respective workers of the distributed computing system 180. The manager of the distributed computing system 170 transmits the assignment notification information 1030 of the tasks toward the respective workers of the distributed computing system 180, and the local priority managers 210 actually receive the assignment notification information 1030 in the nodes 110(B).

As described above, the local priority managers 210 generate the shuffle information 1040 that is the hint of the communication priority control from the received assignment notification information 1030, as described above, and transmit the shuffle information 1040 to the global priority manager 200.

In addition, the local priority managers 210 transmit the assignment notification information 1030 to the workers of the distributed computing system 180, and the workers of the distributed computing system 180 respectively generate the tasks 520(2A) and 520(2B) from the assignment notification information 1030.

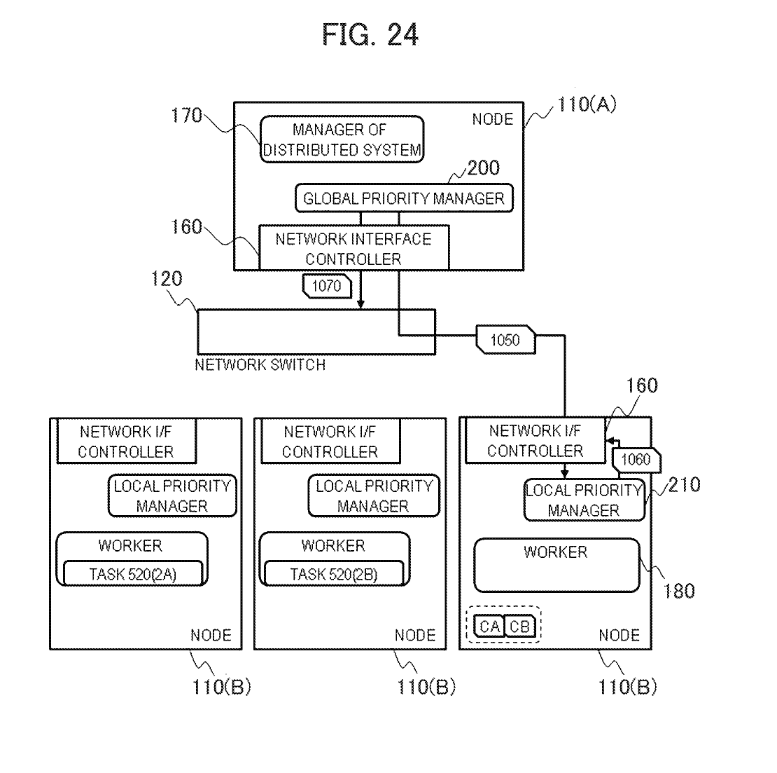

FIG. 24 is a block diagram of a state where the global priority manager 200 sets the priority of communication for the network switch 120 and the local priority manager 210 sets the priority of communication for the NIC 160.

The global priority manager 200 decides the priority of communication for each network switch 120 based on the shuffle information 1040 of the communication priority control collected from the local priority manager 210, and generates the priority setting information 1070. Then, the global priority manager 200 uses the priority setting information 1070 to set the priority of communication for the network switch 120. In addition, the global priority manager 200 decides the priority of communication for the NIC 160 in the same manner, and notifies the priority control information 1050 to the local priority manager 210.

The local priority manager 210 sets the priority of communication to the NIC 160 based on the received priority control information 1050.

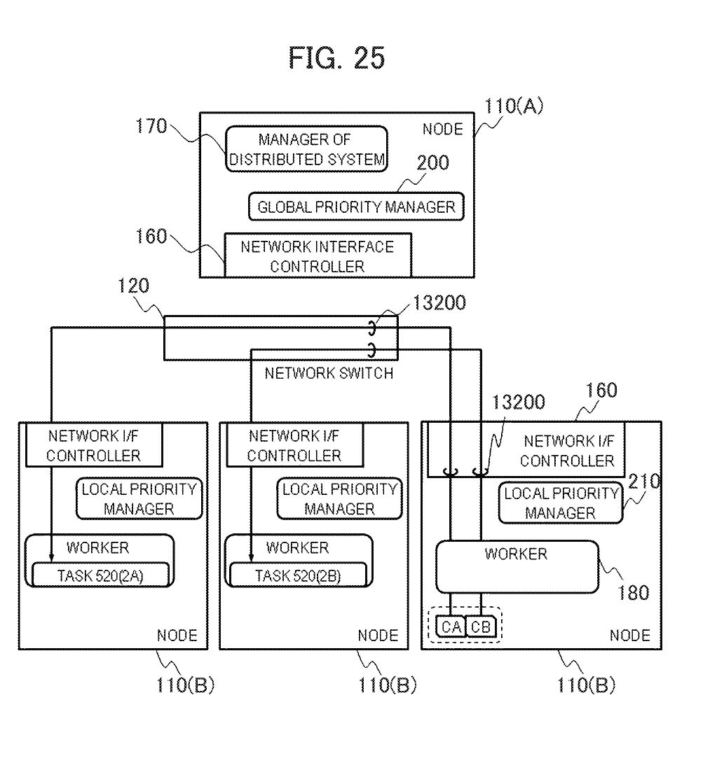

FIG. 25 is a block diagram representing a state where each of the partial data 191(CA) and the partial data 191(CB) is transferred via the network switch 120 and the NIC 160 in which the priority is controlled.

In FIG. 25, the global priority manager 200 and the local priority manager 210 are not involved in the transfer of the partial data 191, and the priority controlling function that the network switch 120 and the NIC 160 have controls the priority for the partial data 191 (13200).

### Monitoring

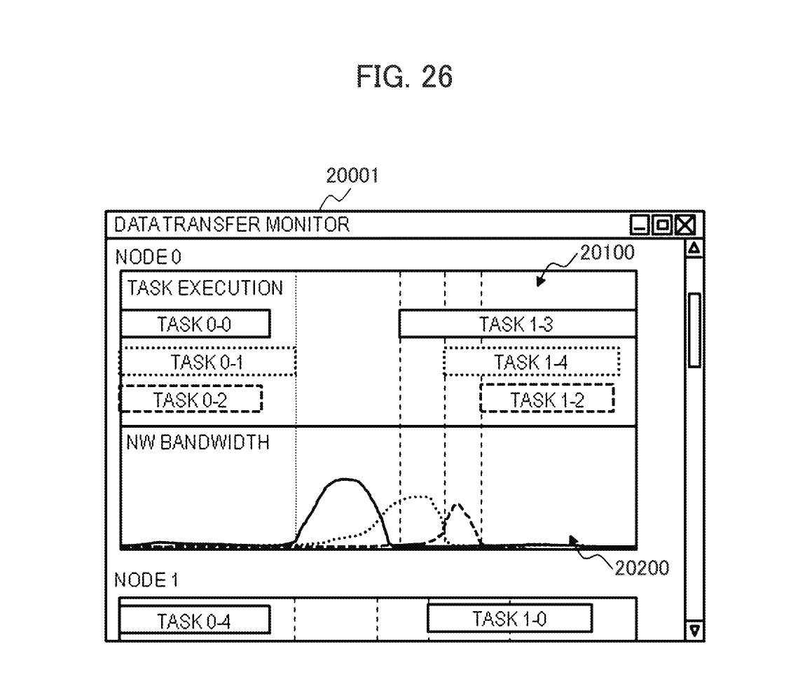

FIG. 26 is a diagram illustrating an example of a screen 20001 that represents the communication state of the tasks 520 being executed. It should be noted that the screen 20001 represents one form of the user interface performing monitoring when the present invention is executed. For example, the screen 20001 is displayed to the input-output device 155 of the node 110(A) by the manager of the distributed computing system 170.

The start and completion of each task 520 are displayed in a region 20100 in the drawing, and the effective bandwidths of the network are graphically displayed in a region 20200. The user and manager using the node 110(A) visually examines this user interface, and thus can confirm a state where the shuffle (the partial data 191) of the task 520 in which the execution time is long is transferred on a priority basis, and the execution of the task 520 is started early. By the user interface representing such the statistical information, it is possible to confirm that the present invention is applied.

As described above, in the first embodiment, the global priority manager 200 is added to the manager of the distributed computing system 170 in the node 110(A), and the local priority manager 210 is added to the worker of the distributed computing system 180 in the node 110(B). Then, the global priority manager 200 sets the priority for the task 520 assigned to the worker of the distributed computing system 180 high when the size of the processed data 190 is large, thereby setting the order according to the priority to the network device.

With this, the variation in the completion time of the tasks 520 occurring in the distributed computing is reduced without modifying the software of the distributed computing system 100 (the manager of the distributed computing system 170 and the worker of the distributed computing system 180), and the execution time of the job introduced into the distributed computing system 100 can be shortened.

It should be noted that in the first embodiment, the example in which the priority is set to both of the network switch 120 and the NIC 160 is illustrated, but when the priority control of each node 110(B) is enabled only by the network switch 120, the priority may be set only to the network switch 120.

### Second Embodiment

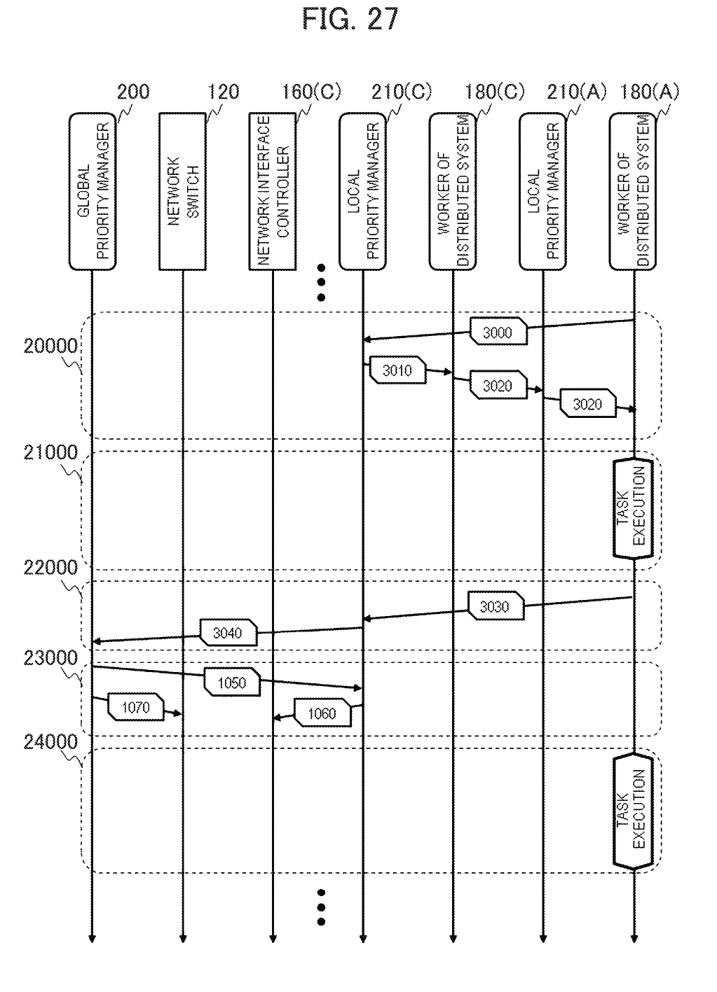

FIGS. 27 to 35 illustrate a second embodiment of the present invention. In the second embodiment, an example is illustrated in which the function 1-3 of the global priority manager 200 illustrated in the first embodiment is changed. It should be noted that other configurations are the same as the first embodiment.

As the algorithm deciding the priority of communication, in the first embodiment, the high priority is assigned to the task 520 having a large data size, but in the second embodiment, an example is illustrated in which the priority of communication is set high to the task 520 in which the value of “the computing time per unit data size”×“the data size” is large instead of using the value of the simple data size.

FIG. 27 illustrates a sequence diagram illustrating an example of the data priority control performed in the distributed computing system 100 of the second embodiment. In addition, procedures 20000, 22000, and 23000 of FIG. 27 will be respectively described with FIGS. 33, 34, and 35 in which the description of the moving state of data is added to the configuration of FIG. 1 illustrated in the first embodiment.

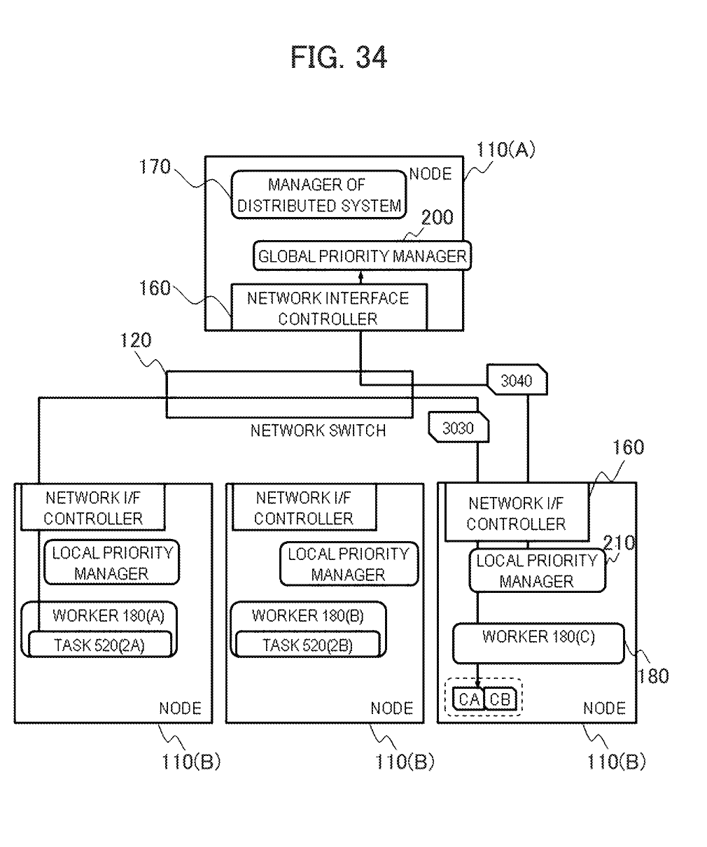

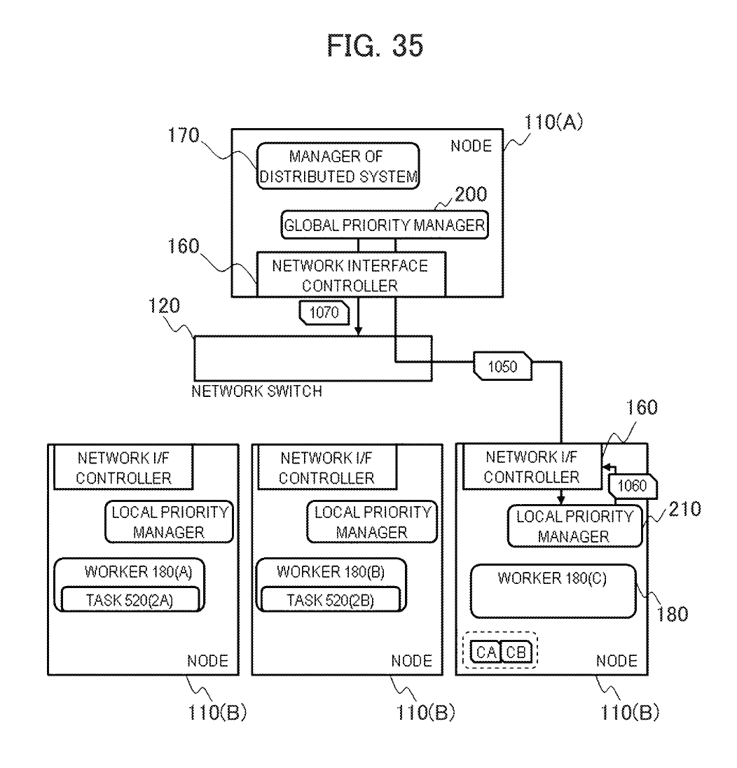

It should be noted that FIG. 33 is a block diagram illustrating an example in which the processed data is transmitted between the workers of the distributed computing system 180. FIG. 34 is a block diagram illustrating an example in which the measurement data of the computing time of the task 520 is collected. FIG. 35 is a block diagram illustrating an example in which the global priority manager 200 sets the priority control information to the network switch 120, and the local priority manager 210 sets the priority control information to the NIC 160.

As illustrated in FIG. 33, in the procedure 20000 of FIG. 27, a worker of the distributed computing system 180(A) requests processed data 190(CA) with respect to a worker of the distributed computing system 180(C) via a local priority manager 210(C). The worker of the distributed computing system 180(C) responds to the worker of the distribution computing system 180(A) via a local priority manager 210(A).

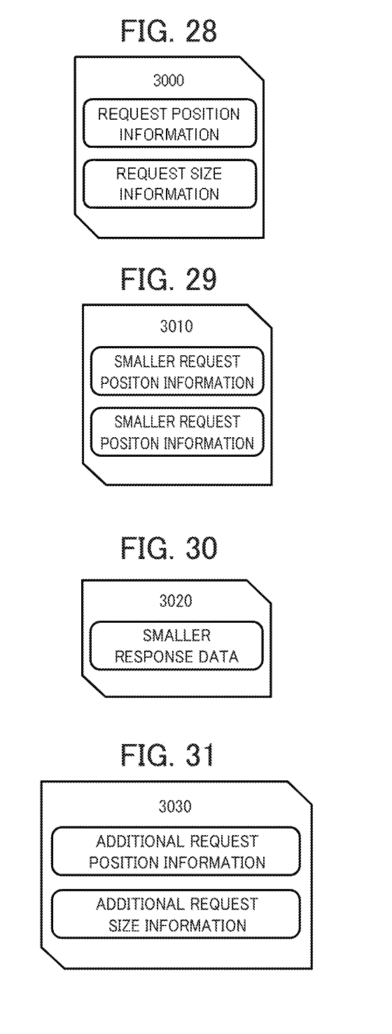

At this time, the local priority manager 210(C) receives, from the worker of the distributed computing system 180(A), request information 3000 including the position of the request data and the request size of the data as illustrated in FIG. 28.

The local priority manager 210(C) refers to the request information 3000, and transmits, to the worker of the distributed computing system 180(C), request information 3010 as illustrated in FIG. 29 in which the request size is rewritten to a smaller value.

Then, the worker of the distributed computing system 180(C) returns processed data 3020 as illustrated in FIG. 30 having a size smaller than the originally requested size, to the worker of the distributed computing system 180(A).

In a procedure 21000 of FIG. 27, the worker of the distributed computing system 180(A) computes the processed data having a size smaller than the request size.

As illustrated in FIG. 34, for the unreceived data, the worker of the distributed computing system 180(A) transmits request information 3030 illustrated in FIG. 31 to the local priority manager 210(C) in the procedure 22000. FIG. 31 is a diagram illustrating an example of the additional request information 3030 that the worker of the distributed computing system 180(A) that is the request source of the processed data 190 notifies to the worker of the distributed computing system 180(C) that is the request destination of the processed data 190.

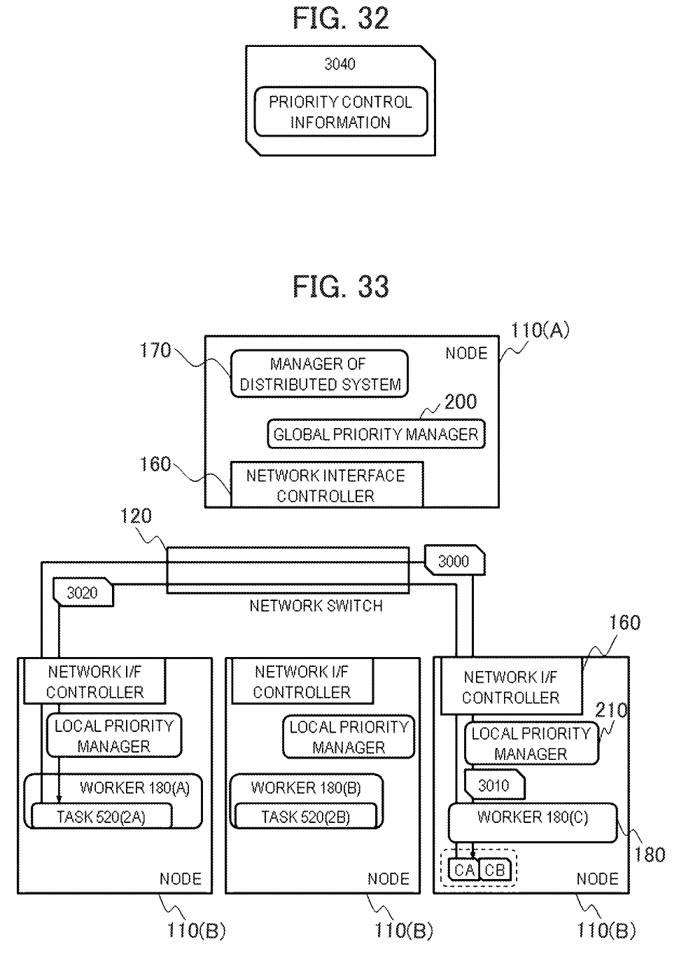

The local priority manager 210(C) transmits, to the global priority manager 200, priority control information 3040 as illustrated in FIG. 32 including the data size transmitted to the worker of the distributed computing system 180(A) and the measurement value of the time from the reception of the request information 3000 to the reception of the request information 3030.

FIG. 32 is a diagram illustrating an example of the priority control information 3040. The time from the point of time at which the local priority manager 210(C) transmits the request information 3010 including the data size to the worker of the distributed computing system 180(C) that is the request destination of the processed data 190 to the point of time at which the local priority manager 210(C) receives the additional request information 3030 from the worker of the distributed computing system 180(A) is measured.

The local priority manager 210(C) estimates, from the measurement value of the time, the computing time of the processed data 3020 having a smaller data size, and generates the priority control information 3040 from the data size and the estimation value of the computing time of the smaller processed data 3020.

Alternatively, the time during which the CPU utilization rate is above a fixed value after the local priority manager 210(A) receives the smaller processed data 3020 may be measured to transmit the priority control information 3040 including the time to the global priority manager 200. At this time, with the lowering of the CPU utilization rate, the transfer request for the remaining data may be transmitted from the local priority manager 210(A) to the local priority manager 210(C). With this, the computing can be restarted without waiting for the retransmission of the request information 3030 from the worker of the distributed computing system 180(A).

In the second embodiment, the local priority manager 210(C) for the worker of the distributed computing system 180(C) that is the transmission source of the processed data 190 changes the data size of the processed data 190 transmitted to the worker of the distributed computing system 180(A), and transmits the request information 3010 having a data size smaller than the data size originally transmitted, to the worker of the distributed computing system 180(C).

The worker of the distributed computing system 180(C) transmits the processed data 3020 having a smaller data size, thereby allowing the worker of the distributed computing system 180(A) to execute the processed data 3020. When completing the computing of the processed data 3020, the worker of the distributed computing system 180(A) transmits the additional request information 3030 for requesting the next data.

The local priority manager 210(C) estimates the computing time of the processed data 3020 having a smaller data size from the time at which the local priority manager 210(C) receives the additional request information 3030 from the worker of the distributed computing system 180(A) and the time at which the local priority manager 210(C) transmits the request information 3010.

It should be noted that the size of the processed data 3020 is sufficient if the computing time in the worker of the distributed computing system 180(A) can be estimated, and for example, is the predetermined data size, such as several percent of the data size of the processed data 190 and several hundreds of megabytes.

As illustrated in FIG. 35, in the procedure 23000 of FIG. 27, the global priority manager 200 predicts the computing time of the task 520 from the priority control information 3040, and decides the priority of communication. Then, the global priority manager 200 transmits, to the local priority manager 210, the priority control information 1050 related to the priority of communication as illustrated in FIG. 11 of the first embodiment.

It should be noted that in FIG. 27, the example is illustrated in which the processed data 3020 having a smaller data size is transmitted from the worker of the distributed computing system 180(C) to the worker of the distributed computing system 180(A) to measure the computing time, but the same computing is performed to other workers of the distributed computing system 180 computing the tasks 520.

Thereafter, the local priority manager 210 sets the setting information 1060 of the priority of communication as illustrated in FIG. 12 of the first embodiment to the NIC 160, and the global priority manager 200 sets the setting information 1070 of the priority of communication as illustrated in FIG. 13 to the network switch 120.

In the second embodiment, the global priority manager 200 decides the priority of communication for the task 520 based on the estimation value of the computing time, in addition to the size of the processed data 190 computed by the task 520. With this, also in the second embodiment, the variation in the completion time of the tasks 520 occurring in the distributed computing is reduced without modifying the software of the distributed computing system 100, and the execution time of the job introduced into the distributed computing system 100 can be shortened.

Also, the processed data 3020 having a sufficiently smaller data size than the processed data 190 originally computed is used for the estimation of the computing time of the worker of the distributed computing system 180(A), so that the variation in the completion time of the tasks 520 can be reduced.

### Third Embodiment

In a third embodiment of the present invention, an example in which the task reexecuted at a failure is prioritized is illustrated. It should be noted that other configurations are the same as the first embodiment.

In the third embodiment, when a failure occurs in any one of the nodes 110(B) illustrated in FIG. 1 and the task 520 is reexecuted, the shuffle of the task 520 is computed on a top-priority basis. It should be noted that in the third embodiment, the local priority manager 210 includes a failure detection unit, and detects failure occurrence in the node 110(B).

When the local priority manager 210 detects that a failure occurs in its own node 110(B) and the computing of the worker of the distributed computing system 180 cannot be continued, the local priority manager 210 allows the worker of the distributed computing system 180 of another node 110(B) to take over the computing.

In the node 110(B) that takes over the computing, at reassignment of the task 520 to the worker of the distributed computing system 180, the local priority manager 210 relays reassignment information. The local priority manager 210 detects the reassignment to transmit the reassignment information to the global priority manager 200.

When receiving the reassignment information, the global priority manager 200 immediately executes the transfer of the processed data 190 by increasing the priority for the data transfer to the task 520 with respect to the node 110(B) that is the data transfer source, and makes the catch-up of the task 520 in which the failure has occurred faster.

As described above, in the third embodiment, by setting the priority for the processed data 190 transferred to the task 520 reexecuted at failure occurrence high, the transfer of the processed data 190 to the task 520 reexecuted can be prioritized.

It should be noted that the present invention is not limited to the above embodiments, and includes various modifications. For example, the above embodiments have been described in detail for simply describing the present invention, and do not necessarily include all the described configurations. Also, part of the configuration of one of the embodiments can be replaced with the configurations of the other embodiments, and in addition, the configuration of one of the embodiments can be added with the configurations of the other embodiments. Also, to part of the configuration of each of the embodiments, any of the addition, deletion, and replacement of other configurations is applicable singly or in combination.

Also, in the respective configurations, functions, computing units, computing means, and the like, portions or all of them may be achieved by hardware, for example, by designing by an integrated circuit and the like. Also, the respective configurations, functions, and the like may be achieved by software by interpreting and executing the program in which the processor achieves each function. The information of the program, table, file, and the like achieving each function can be placed on a recording device, such as a memory, a hard disk, and an SSD (Solid State Drive), or a recording medium, such as an IC card, an SD card, and a DVD.

Also, the control line and the information line that are considered to be necessary for the description are illustrated, and all the control lines and the information lines are not necessarily represented from a product viewpoint. It may be considered that actually, almost all the configurations are connected to each other.

1. A data controlling method of a distributed computing system that connects a first computer having a processor, a memory, and a network interface and a plurality of second computers each having the processor, the memory, and the network interface by a network device and controls data computed by the second computers, the method comprising:
a first step in which first software operated on the first computer assigns data to be computed to second software operated on the second computers;
a second step in which second managers operated on the plurality of second computers respectively obtain data assignment information notified from the first software, and respectively notify the data assignment information to a first manager operated on the first computer;
a third step in which the first manager decides priority for the data to be computed transferred between the plurality of second computers based on the data assignment information; and
a fourth step in which the first manager sets the priority to the network device.

2. The data controlling method according to claim 1, further comprising:
a fifth step in which the first manager notifies the priority to each of the second managers; and
a sixth step in which the second manager sets the priority received from the first manager to the network interface.

3. The data controlling method according to claim 1,
wherein the third step includes:
a step in which the second manager measures the communication state of the data to be computed between the second computers and the execution time of the second software computing the data to estimate the computing time of a predetermined data size;
a step in which the second manager notifies the estimated computing time to the first manager; and
a step in which the first manager sets the priority according to the magnitude of the estimation value of the computing time notified from the second manager.

4. The data controlling method according to claim 3,
wherein the second manager predicts that as the size of the data to be computed is larger, the computing time is longer,
wherein as the estimation value of the computing time notified from the second manager is larger, the first manager sets the priority higher.

5. The data controlling method according to claim 3,
wherein the second manager uses data having a data size smaller than the data size of the data assignment information to measure the execution time of the second software computing the data, and estimates the computing time of the predetermined data size.

6. The data controlling method according to claim 1,
wherein the third step includes:
a step in which the second manager obtains reexecution information to allow the computing to be taken over;
a step in which the second manager transmits the reexecution information to the first manager; and
a step in which the first manager sets the priority for the data to be computed corresponding to the reexecution information high.

7. A distributed computing system comprising:
a first computer having a processor, a memory, and a network interface;
second computers each having the processor, the memory, and the network interface; and
a network device connecting the first computer and the plurality of second computers,
wherein the second computers have:
workers computing assigned data; and
second managers managing the workers,
wherein the first computer has:
a management unit deciding data to be computed assigned to the plurality of workers and notifying the data as data assignment information to the workers; and
a first manager managing the plurality of second managers,
wherein the plurality of second managers respectively obtain the data assignment information notified from the management unit, and respectively notify the data assignment information to the first manager,
wherein the first manager decides priority for the data to be computed transferred between the plurality of second computers based on the data assignment information received from the second managers, and sets the priority to the network device.

8. The distributed computing system according to claim 7,
wherein the first manager notifies the priority to each of the second managers,
wherein the second manager sets the priority received from the first manager to the network interface.

9. The distributed computing system according to claim 7,
wherein the second manager measures the communication state of the data to be computed between the second computers and the execution time of second software computing the data to estimate the computing time of a predetermined data size, and notifies the estimated computing time to the first manager,
wherein the first manager sets the priority according to the magnitude of the estimation value of the computing time notified from the second manager.

10. The distributed computing system according to claim 9,
wherein the second manager predicts that as the size of the data to be computed is larger, the computing time is longer,
wherein as the estimation value of the computing time notified from the second manager is larger, the first manager sets the priority higher.

11. The distributed computing system according to claim 9,
wherein the second manager uses data having a data size smaller than the data size of the data assignment information to measure the execution time of the second software computing the data, and estimates the computing time of the predetermined data size.

12. The distributed computing system according to claim 7,
wherein the second manager obtains reexecution information to allow the computing to be taken over, and transmits the reexecution information to the first manager,
wherein the first manager sets the priority for the data to be computed corresponding to the reexecution information high.
